(19) United States
(12) Patent Application Publication
(10) Pub. No.: US 2020/0120905 A1
(43) Pub. Date: Apr. 23, 2020

(54) FLOATING AND SUBMERSIBLE HIGH-SEA AQUACULTURE INSTALLATION

(71) Applicant: Serge MENARD, Saint-Julien-de-Gras-Capou (FR)

(72) Inventor: Serge MENARD, Saint-Julien-de-Gras-Capou (FR)

(21) Appl. No.: 16/627,166

(22) PCT Filed: Jun. 27, 2018
(86) PCT No.: PCT/EP2018/000321

§ 371 Date: Dec. 27, 2019

(30) Foreign Application Priority Data
Jun. 27, 2017 (FR) 1700689

(51) Int. Cl. A01K 61/60; B63B 43/06

(52) U.S. Cl. CPC A01K 61/60; B63B 43/06

(57) ABSTRACT

The invention relates to a floating and submersible high-sea aquaculture installation. The objective of the present invention is to create a floating and submersible high-sea aquaculture installation that offers better stability, particularly in its submerged or semi-submerged state. According to the invention, this objective is achieved by a floating and submersible high-sea aquaculture installation (1) comprising a structure (2), fish-rearing cages (3) and at least two first adjustable-ballast floats (4) which are located in the bottom third of the structure (2). The installation (1) according to the invention is characterized in that it further comprises at least two second floats (7) which are located in the top third (8) of the structure and which are able to support at most 50% of the weight of the structure.

This invention concerns a floating and submersible offshore aquaculture installation.

Fish farming in a closed environment develops more and more. For this purpose, numerous mesh cages have been developed where fish can be fattened, kept away from predators, monitored for health and then easily fished when they reach the desired size.

The time for so-called “coastal” marine aquaculture facilities is over. Today, aquaculture is moving out to the open sea to develop offshore.

Several concepts already exist, designed to allow fish farming in more exposed areas. Among these concepts, two categories stand out clearly. Semi-submersible floating installations whose bridge remains emerged on the one hand, and floating submersible installations whose bridge can be immersed at 15 or 20 meters or more below sea level on the other hand.

These two bases of concepts respond in different ways to the problems of the current aquaculture.

In coastal areas, excessive livestock concentrations have produced significant environmental pollution on the one hand, and self-pollution of livestock on the other, leading to the development of diseases and parasites, which has sometimes caused the death of entire livestocks.

The semi-submersible installation concept and the submersible installation concept do not solve these problems with the same efficiency, for purely physical reasons. The higher the wave are, the larger the installation that remains on the surface must be to maintain sufficient stability. This has led to the emergence of floating and semi-submersible installations that are several hundreds of meters long.

These very expensive installations require a production of 8,000 to 10,000 tons of fish to be profitable, which can lead to environmental pollution and significant self-pollution of the farm, in the same way as coastal installations, which consist of sequences of farming cages.

In addition, their permanent surface flotation position exposes them to severe storms and the progress of the climate change whose power increase is constant.

Conversely, a floating, submersible aquaculture facility can be much smaller in size while remaining fairly stable under adverse weather conditions since it can be submerged as soon as the evolution of weather conditions require this.

The cost of a small floating, submersible installation is 4 to 5 times lower than the cost of a large semi-submersible installation. This makes it possible to considerably reduce the tonnage required for its profitability, thus avoiding the inconveniences caused by oversized installations.

However, a small installation is more difficult to make stable on the surface, it may swing with the waves.

Document FR 2 996 723 A1 describes a submersible offshore aquaculture installation that comprises submerged hulls with adjustable ballasts that are installed at the bottom of the structure. The structure also includes a handling bridge and a unique anchoring line allowing the installation to rotate through 360°.

The hulls of this installation being installed at the bottom of the structure are supported by deeper layers of water that are very little subject to the movement of waves at the surface. The installation remains only slightly agitated even under adverse weather conditions.

However, unlike a ship whose hull floats on the water surface, the installation according to document FR 2 996 723 A1 has a low resistance to sinking into the water layer due to the reduced buoyancy of a submerged hull. While the size of its submerged hulls almost eliminates the impact of waves on its floatage stability, this reduced buoyancy can have disadvantages, particularly if the installation is submerged or semi-submerged.

Given this low resistance to sinking, the installation may become sensitive to weight variations of a few tons, for example during loading or distribution of food or various stresses that may have an impact on the installation's trim, such as a moored vessel of a certain size, etc.

The problem has proved to be very difficult and cannot be rectified by conventional surface hulls or floats replacing the submerged hulls because, due to their volume, and starting at a certain wave power, surface hulls or floats would cause the installation to rise to the wave, which would have an immediate impact on the balance of the structure.

The purpose of this invention is to propose a floating and submersible offshore aquaculture installation that is more stable, particularly in its submerged or semi-submerged state.

According to the invention, this goal is achieved by a floating and submersible offshore aquaculture installation comprising a structure, cages for breeding of fish, and at least two first floats having adjustable ballasts, wherein the first floats are located in the lower third of the structure. The installation according to the invention is characterized in that it further comprises at least two second floats, which are arranged in the upper third of the structure and which are capable of supporting at most 50% of the weight of the structure.

The installation according to the invention has a structure and fish breeding cages that are arranged in the structure. The installation is floating and has first floats with adjustable ballasts. Thanks to these adjustable ballasts, the installation can be partially submerged, such that part of the installation, such as a handling bridge, remains above the water surface, or can be completely submerged, such that the entire structure is below the water surface.

The first floats are placed in the lower third of the structure to be supported by water layers that remain relatively calm in relation to the water surface, which can be agitated and can show waves.

The presence of the second floats in the upper third of the structure provides reserve buoyancy to the installation when the installation is at its floating level, which considerably increases its resistance to sinking.

Advantageously, the first and/or the second floats can be arranged on two opposite sides of the installation. Thus, the structure can easily be oriented in the direction of a current if the installation is anchored at a point in the environment of the installation. The defined orientation of the installation in relation to the current allows a defined and controlled distribution of feed to the fish. In addition, the cages can preferably be longitudinal cages. They can be oriented in the current in such a way that their largest extent is oriented in the direction of the current. This allows fish to swim a long distance against the current. Fish farming in a relatively natural environment can be ensured.

Advantageously, the first floats can be shaped like a hull. If hull-shaped floats are installed at the bottom of the structure, particularly along two opposite sides, the orientation of the installation in the currents is further improved. In addition, the installation has a reduced resistance to water flow. The anchoring point and anchoring line are less stressed.

The first and/or the second floats can also be placed around the entire perimeter of the installation. This arrangement stabilizes the installation in all directions and allows, for example, the mooring of a ship on either side of the installation.

The floats, and in particular the second floats, can be vertically movable. Their position can be adjusted to different heights, depending on the condition of the sea, to enhance the stability of the installation. In particular, the second floats can provide considerable additional stability if they are close to the water surface. Depending on the immersion level of the installation, the position of the floats can be adjusted so that they can remain close to the water surface.

For maximum stability of the installation, the first and/or the second floats may also consist of several separate floats which may be installed at the ends of the installation, in particular in a horizontal plane, and at maximum distance from each other.

The second floats can be equipped with adjustable ballasts like the first floats. Thus, their buoyancy can be adjusted according to the needs. For example, the second floats can have considerable reserve buoyancy if the sea is calm. The structure can be supported by the first and the second floats, and the installation floats. If the sea is rough, the second floats can be ballasted to support the installation further on the first, lower floats in a calmer water area.

Preferably, the second floats are capable of supporting a maximum of 33% of the weight of the structure, and preferably a maximum of 25% of the weight of the structure. Thus, the second floats can ensure a high stability of the installation, which is still supported by lower water layers in the region of the first floats.

The installation may include a ballast control system for the first and the second floats that provides a precise distribution of buoyancy between the first and the second float ballasts, including a relationship in which the first floats carry more than 50% of the weight of the structure.

The installation may also comprise a frame of the structure that includes floating elements, such as hollow tubes. In this case, the effective weight of the submerged and semi-submerged structure is reduced. However, the distribution of the weight carried by the first and second floats remains the same.

The second floats can be simply attached to the frame of the installation, may be vertically movable, or can be removable and can be installed at different levels of the installation. This allows the floating level of the installation to be changed. The second floats can also be integrated into the frame of the installation.

The volume of buoyancy required for the installation is therefore shared between that of the first, permanently immersed floats of large dimensions and that of the second, smaller, so-called surface floats, which are mainly used to provide the reserve buoyancy necessary for the stability of the installation, while providing a reduced grip on wave impact.

This reserve buoyancy can be distributed over the entire length of the installation thanks to the second floats. It is large enough to compensate for the variations in weight and various stresses resulting from the operation of the installation, but remains limited to prevent the installation from pitching at the whim of the waves.

The operation of the installation becomes safer and easier to manage, especially if its resistance to sinking and stability can be fully regulated from the specific ballast controls of the first and/or the second floats.

The first submerged and ballasted floats can be weighted in order to lower the center of gravity of the installation or to help stabilize the base of the installation during the immersion phase.

Additional weights may be suspended under the installation at the end of chains or other means, of a length calculated to slow down and completely stop its immersion at a certain depth when the weights touch the seabed. These weights may consist of very heavy chains only, of a length calculated to achieve the same result.

These additional weights can be used as articulated feet and stabilizers that are totally reliable in the event of a major storm. In addition, they guarantee that the installation cannot fall below a specific immersion threshold.

The second floats, which have a certain width and are arranged on the lateral faces of the installation at the height of its floating level, may be equipped with horizontal surfaces arranged as footbridges or platforms forming a dock for docking ships, which may facilitate access to the bridge of the installation and provide safety of persons. They may also include watertight access doors and bunkers for the storage of equipment or other uses.

The installation in accordance with the invention may include an anchoring line that allows it to rotate 360° in areas of up to 100, 200 or even 300 meters or more, and may also be subjected to loads due to the high weight of the anchoring line, which may vary depending on the level of flotation or immersion of the installation.

This weight load will be created at the front of the installation, at its mooring point(s) to the anchoring line. This problem is solved by the presence of one or more floats equipped with adjustable ballasts located at the front of the installation, which makes it possible to regulate and preserve its attitude.

These first floats may be made by extending the front of the first floats, may have a bow or appendage shape, be installed at the front and bottom of the installation or at its float level, or both, or in any other suitable arrangement.

These floats are shaped to perform the function of breakwaters when installed at the height of the installation's float line.

Simple breakwaters can also be installed on the front face of the installation or be an integral part of the front face frame of the installation.

Such an installation may include a mast that carries remote control, monitoring and miscellaneous communications devices. It makes it possible to locate the location of the installation when it is submerged, its attitude, the exact depth of immersion by means of scales affixed to the mast. It can also receive various physical connection devices accessible from a ship when the installation is submerged, to transfer energy, compressed air, feed, or operate any controls.

The mast may include an emergency buoyancy reserve of the installation in the form of automatically inflatable airbags.

The installation is designed for offshore use, and may therefore be subject to difficult weather conditions, which may complicate access to the installation, some docking operations, or handling from a ship.

To facilitate these operations, the installation can be equipped with a dock located on the rear side of the installation. It can have different shapes, be streamlined, fixed on the rear face of the installation, be ballasted, floating or vertically movable, to create a quieter area to facilitate these operations and reduce the risk of collision with the installation, since the ship will be pulled back by the current it will face. This dock, whether or not streamlined, can be equipped with various access devices to the installation deck, and include all necessary connections to service the installation.

The installation deck can be equipped with shielded, non-watertight corridors, allowing men to move on the bridge of the installation, sheltered from waves and the elements (winter winds, rain, etc.) and providing greater safety for work at night.

As the anchoring line is very heavy, it may be equipped with one or more flotation volumes fixed at different intervals or at a specific location, in the form of spheres, cylinders or any other shape, or it may be equipped with a floating sheath over all of its length or a part of its length only.

The invention is explained more precisely below with reference to the appended figures which show different embodiments of the invention in a schematic way:

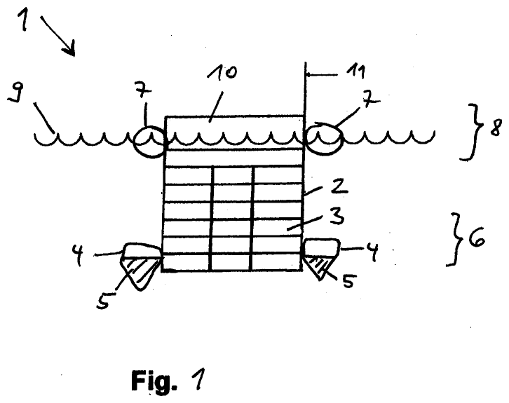

FIG. 1 illustrates an embodiment of an aquaculture installation in accordance with the invention in rear view;

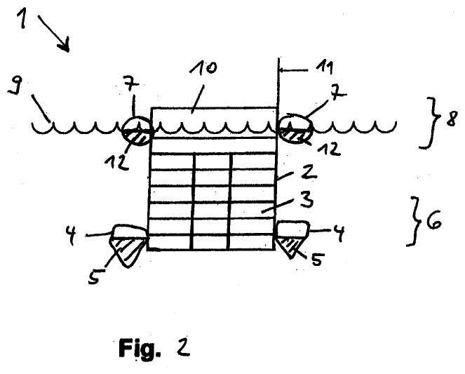

FIG. 2 illustrates another embodiment of an aquaculture installation in accordance with the invention in rear view;

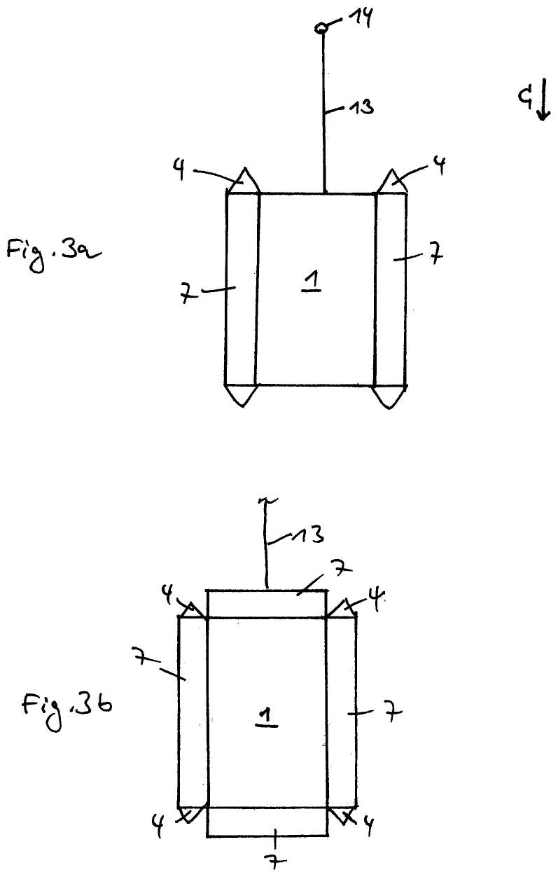

FIGS. 3a and 3b show aquaculture installations in accordance with the invention from above.

FIG. 1 shows an embodiment of an aquaculture installation in accordance with the invention in rear view. It is specified that this figure, as well as the other figures, show the installation in a purely schematic way to explain the general mode of operation of the invention. The figures are neither to scale nor complete but show schematically only those elements that are necessary to assess the invention.

The installation 1 includes a structure 2 that comprises cages 3 for breeding of fish. The installation also includes at least two first floats 4 with adjustable ballasts 5. The first floats 4 are located in the lower third 6 of structure 2. The first floats 4 are in the form of a hull.

The installation 1 includes further at least two second floats 7 which are arranged in the upper third 8 of the structure and which are capable of supporting at most 50% of the weight of the structure.

Thus, the second floats 7 have a reserve buoyancy that makes the structure stable when subjected to external stresses. However, the second floats 7 are too small to carry the weight of the installation alone. The installation remains stable even with high waves on the water surface 9.

An installation with a length of 70 to 100 meters is expected to remain stable in the presence of waves of 5 to 7 meters or more, which is an operating margin that is more than sufficient for a submersible aquaculture facility.

The installation may include, as shown in FIG. 1, a handling bridge 10 that remains in the unsubmerged state of the installation 1 above the water surface 9. The installation can be completely submerged, for example to protect it from storms, by ballasting the first floats 4. In this case, the mast 11 of the installation remains above the water surface 9 to be able to transmit and receive radio signals. The installation can thus be controlled by radio signals and, for example, its flotation level can be controlled remotely.

FIG. 2 shows an installation that is similar to the installation of FIG. 1 but has second floats with adjustable ballasts 12. The ratio between the weight of the structure supported by the first and second floats 4, 7 can be adjusted very finely, while keeping the ratio of less than 50% of the weight supported by the second floats 7.

FIG. 3a shows an embodiment of an aquaculture installation in accordance with the invention from above. The installation has a longitudinal shape. The floats 4, 7 are arranged along the longest side faces. The first floats 4 installed in the lower third of the installation are hull-shaped.

The installation further comprises an anchoring line 13 which is fixed to a single point 14 in the environment of the installation. Lateral floats 4, 7 allow easy orientation of the installation in a water stream C. Quick orientation is further facilitated by the first hull-shaped floats 4.

FIG. 3b shows another embodiment of an aquaculture installation in accordance with the invention in top view. The installation also has a longitudinal shape but has second floats 7 around the entire perimeter of the installation. This configuration makes the installation even more stable in relation to the effect of waves, however, its orientation in water currents can be slightly slowed down.

1. Floating and submersible offshore aquaculture installation comprising
a structure, cages for breeding of fish, and at least two first floats having adjustable ballasts, wherein the first floats are located in the lower third of the structure, characterized in that the installation comprises further at least two second floats, the second floats being located in the upper third of the structure, and the second floats being capable to support at most 50% of the weight of the structure.

2. Installation according to claim 1, characterized in that the first and/or second floats are arranged on two opposite sides of the installation.

3. Installation according to claim 1, characterized in that the first floats have the shape of a hull.

4. Installation according to claim 1, characterized in that the first and/or second floats are arranged around the entire perimeter of the installation.

5. Installation according to claim 1, characterized in that the floats are vertically movable.

6. Installation according to claim 1, characterized in that the first floats and/or the second floats are installed at the ends of the installation at a maximum distance from each other.

7. Installation according to claim 1, characterized in that the second floats have adjustable ballasts.

8. Installation according to claim 1, characterized in that the second floats are capable of supporting a maximum of 33% of the weight of the structure, and preferably a maximum of 25% of the weight of the structure.

9. Installation according to claim 7, characterized in that the installation comprises a ballast control system for the first and second floats which makes it possible to achieve a precise distribution of buoyancy between the ballasts of the first and second floats, in particular a distribution in which the first floats carry more than 50% of the weight of the structure.

10. Installation according to claim 1, characterized in that the installation comprises a frame that includes floating elements, in particular hollow tubes.

11. Installation according to claim 8, characterized in that the installation comprises a ballast control system for the first and second floats which makes it possible to achieve a precise distribution of buoyancy between the ballasts of the first and second floats, in particular a distribution in which the first floats carry more than 50% of the weight of the structure.
